(19) United States
(12) Patent Application Publication
(10) Pub. No.: US 2014/0298706 A1
(43) Pub. Date: Oct. 9, 2014

(54) Mechanical Waterfowl Decoy

(71) Applicant: Hayes Brandon Turner, Cabot, AR (US)

(72) Inventor: Hayes Brandon Turner, Cabot, AR (US)

(21) Appl. No.: 14/245,582

(22) Filed: Apr. 4, 2014

Related U.S. Application Data
(60) Provisional application No. 61/808,213, filed on Apr. 4, 2013.

(51) Int. Cl. A01M 31/06

(52) U.S. Cl. CPC A01M 31/06
USPC 43/2

(57) ABSTRACT

A mechanical waterfowl decoy to be used in water. It has a buoyant body and a motor that rotates a decoy head in a circular manner which provides propulsion and water disturbance for the decoy to give the appearance of a duck swimming and diving its head under water to feed.

### BACKGROUND OF THE INVENTION

The present invention is in the technical field of waterfowl decoys. More particularly, the present invention is in the technical field of mechanically operated waterfowl decoys. More particularly, the present invention is in the technical field of mechanically operated waterfowl decoys with mechanical heads.

Conventional mechanical waterfowl decoys have mechanical movement of various body parts including the head. The head motion of these decoys is often complex in operation and is intended to imitate the natural head movement of ducks, not serve as a means of propulsion for the decoy itself nor as a source of water displacement.

### SUMMARY OF THE INVENTION

The present invention is a mechanically operated waterfowl decoy, having a head, that automatically rotates 360 degrees vertically, perpendicular to the body of the decoy, cycling through the water, through the body of the decoy, returning to an upright position.

The advantages of the present invention include, without limitation, that it is relatively simple in mechanical operation. The 360 degree rotation of the decoy head serves as the decoy's means of propulsion, allowing it to swim around automatically. The 360 degree rotating decoy head also creates splashing and rippling superior to that of traditional mechanical waterfowl decoys, particularly those with mechanical moving heads

In broad embodiment, the present invention is a waterfowl decoy that has a motor driven, vertically rotating head, that rotates 360 degrees, cycling through the water and body of the decoy.

### BRIEF DESCRIPTION OF THE DRAWING

These and other features, aspects, and advantages of the present invention will become better understood with regard to the following description, appended claims, and accompanying drawings where:

FIG. 1 is a perspective view of a mechanical waterfowl decoy of the present invention;

FIG. 2 is a perspective view of a mechanical waterfowl decoy of FIG. 1. with portions open to show detail.

FIG. 3 is a side view of a mechanical waterfowl decoy of the present invention;

FIG. 4 is a side view of a mechanical waterfowl decoy of the present invention.

FIG. 5 is a perspective view of a mechanical waterfowl decoy of the present invention.

FIG. 6 is a perspective view of a mechanical waterfowl decoy of the present invention.

FIG. 7 is a top view of a mechanical waterfowl decoy of the present invention.

FIG. 8 is a bottom view of a mechanical waterfowl decoy of the present invention.

FIG. 9 is a perspective view of a second embodiment of the of the present invention

FIG. 10 is a perspective view of a mechanical waterfowl decoy of the present invention.

### DETAILED DESCRIPTION OF THE INVENTION

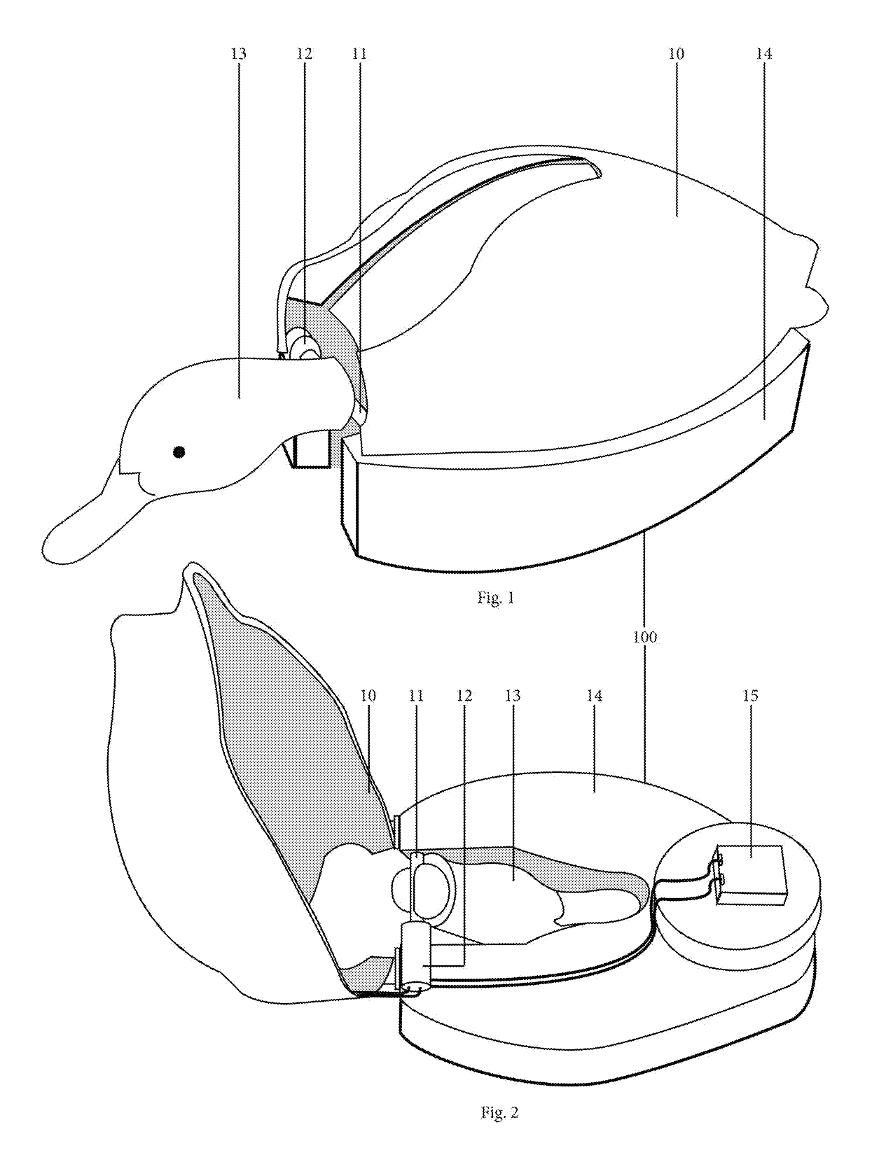

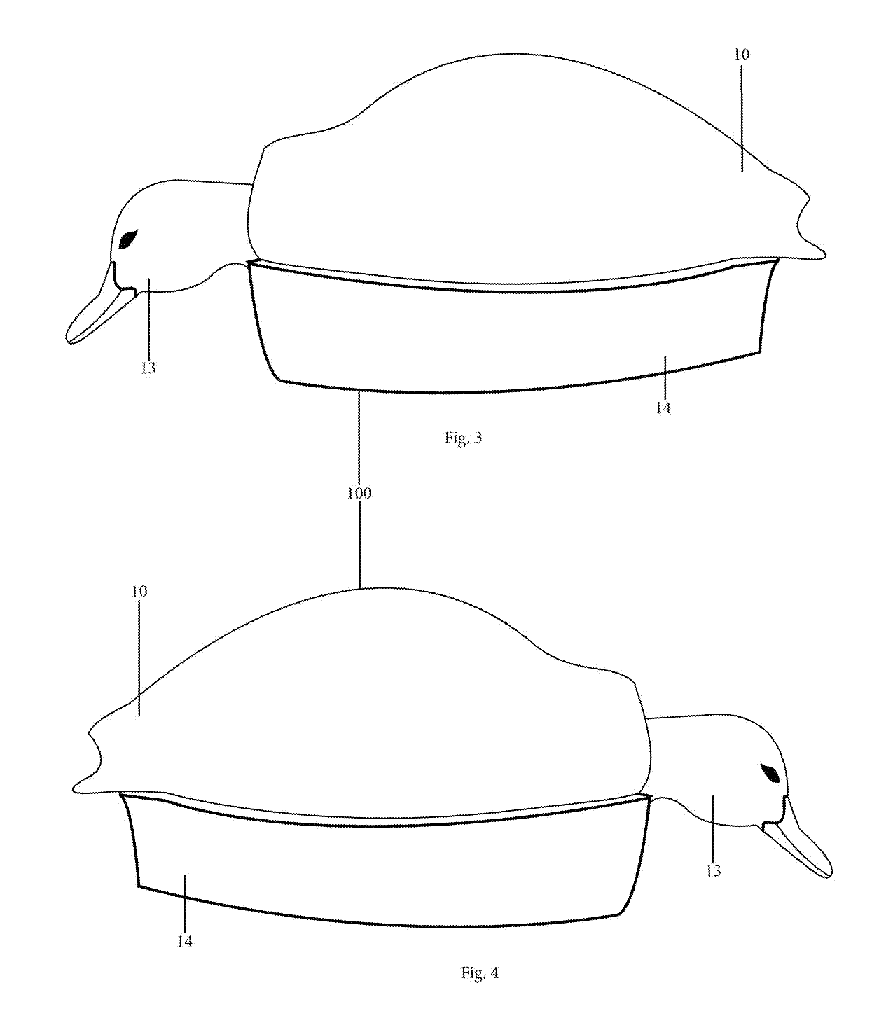

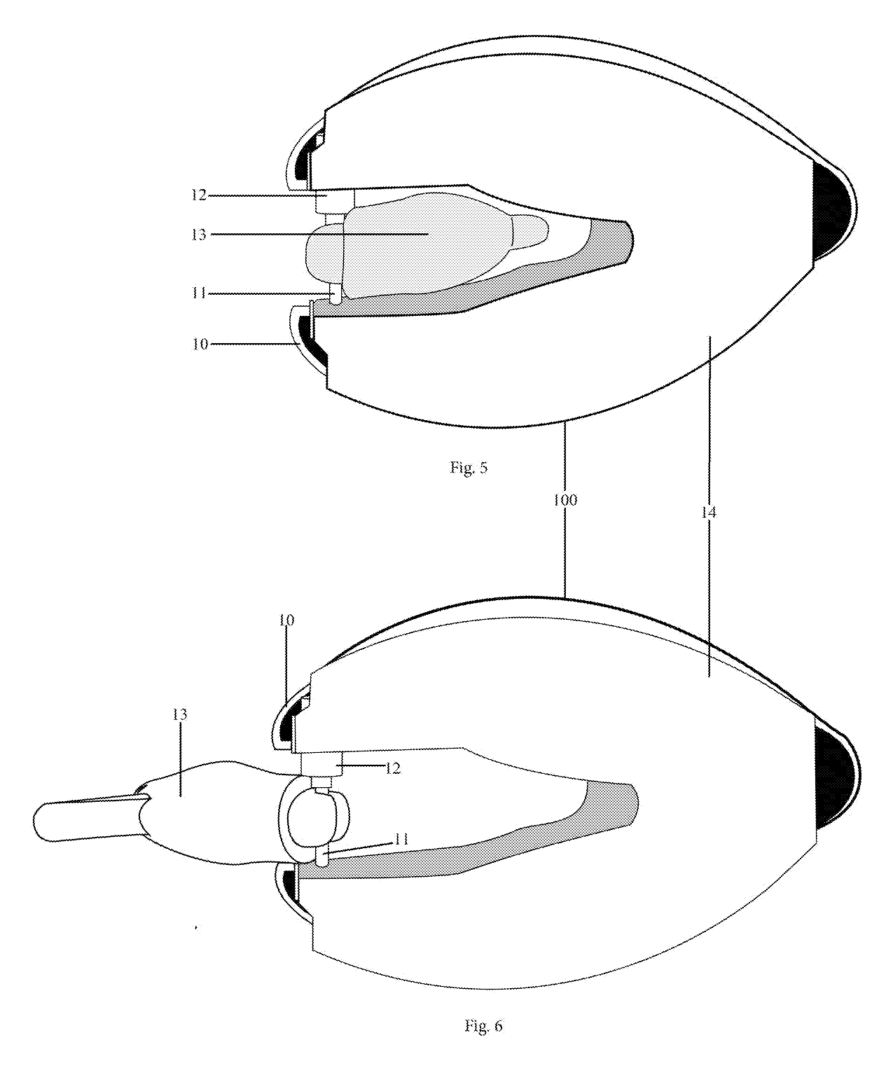

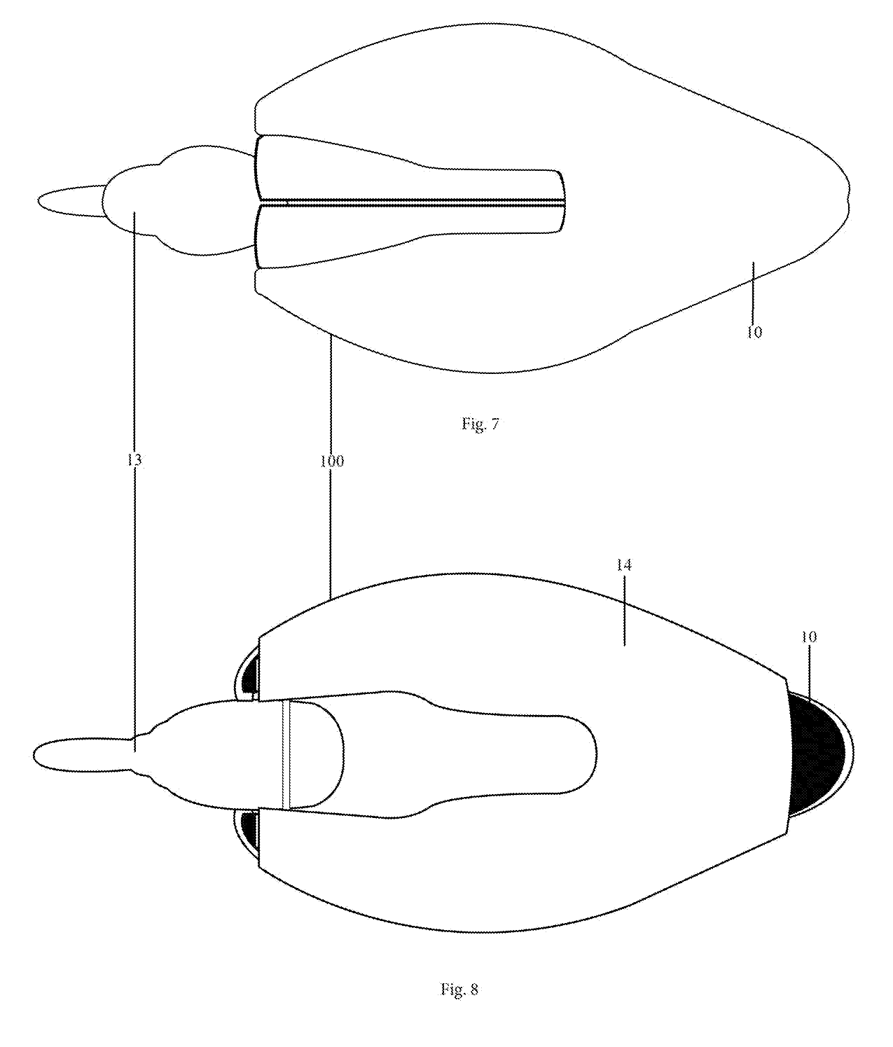

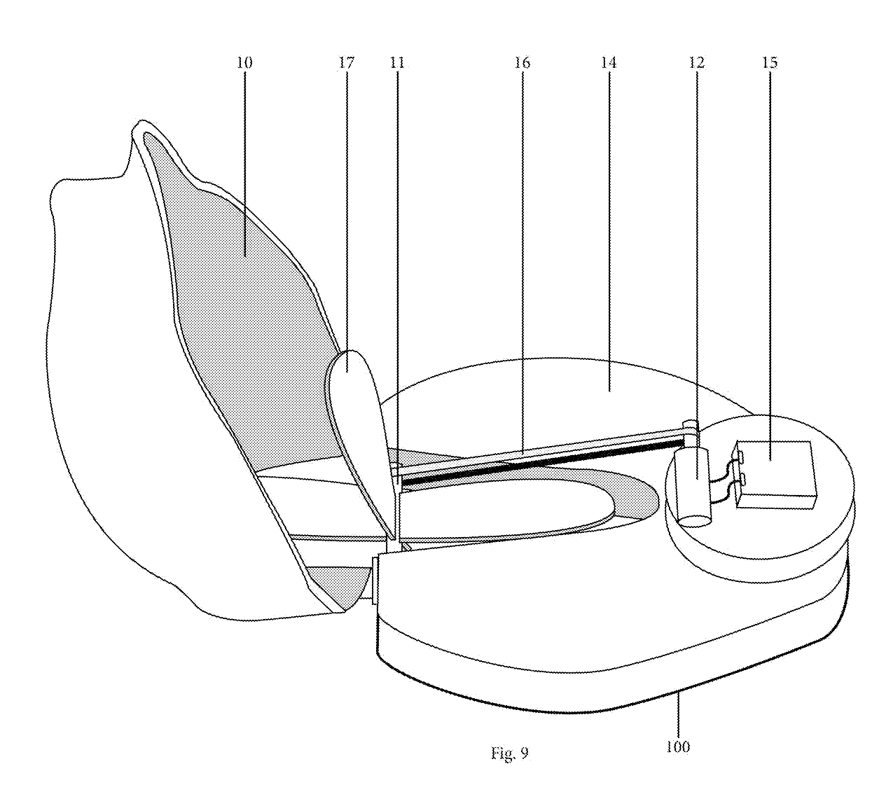

Referring to the drawings, FIG. 1 depicts an embodiment of a mechanical waterfowl decoy 100 having a buoyant decoy body 14 with an access panel 10, a motor 12, a shaft 11 which is connected to the motor 12, and a decoy head 13 which is attached to the attachment shaft 12.

Referring to the drawings, FIG. 2 depicts an embodiment of a mechanical waterfowl decoy 100 with its access panel 10 of the decoy body 14 open to allow access to the power source 15 and the motor 12.

The buoyant decoy body 14 is sufficiently wide, long, and tall enough for encasing and providing sufficient flotation for the mechanical elements of the mechanical waterfowl decoy 100 and retaining a realistic size of that of any particular waterfowl, in this case, a duck. Sufficient size is between 12 long 20 inches long with a width of approximately 50% of the length and a height approximately equal to the width. The decoy head 13 is sized proportionate to the body 11 to retain the realistic proportions of a duck

The construction details of the invention as shown in FIG. 1 are that the mechanical waterfowl decoy 100 may be made of plastic or of any other sufficiently rigid material that could be made buoyant such as polystyrene, wood, metal, or composite material. Further, the various components of the mechanical waterfowl decoy 100 can be made of different materials. The buoyant body 14 has a “U” shape to permit clearance for the decoy head 13 during operation of the decoy. The decoy body 14 also has an access panel 10 configured to open to allow access to the inside of the decoy body 14 where the motor 12 and power source 15 are located.

The mechanical waterfowl decoy 100 operates by way of the decoy head 13 rotating on a shaft 11 which is powered by a motor 12. The motor may be powered electrically, mechanically, or via steam or internal combustion. The motor 12 may also be connected to a power source 15 to supply the motor with electrical or mechanical power. The power source 15 may be integral to or separate from the motor 12. The motor 12 causes the shaft 11 to rotate which, in turn, causes the decoy head 13 to rotate about the shaft. The shaft 11 is oriented horizontally and perpendicular to the longitudinal axis of the decoy 100. The decoy head 13 rotates in a circular motion around the shaft 11. While the decoy 100 is floating in a liquid, the rotation of the decoy head 13 causes the decoy head 13 to pass under the liquid's surface which provides disturbance to the liquid's surface and propels the decoy 100.

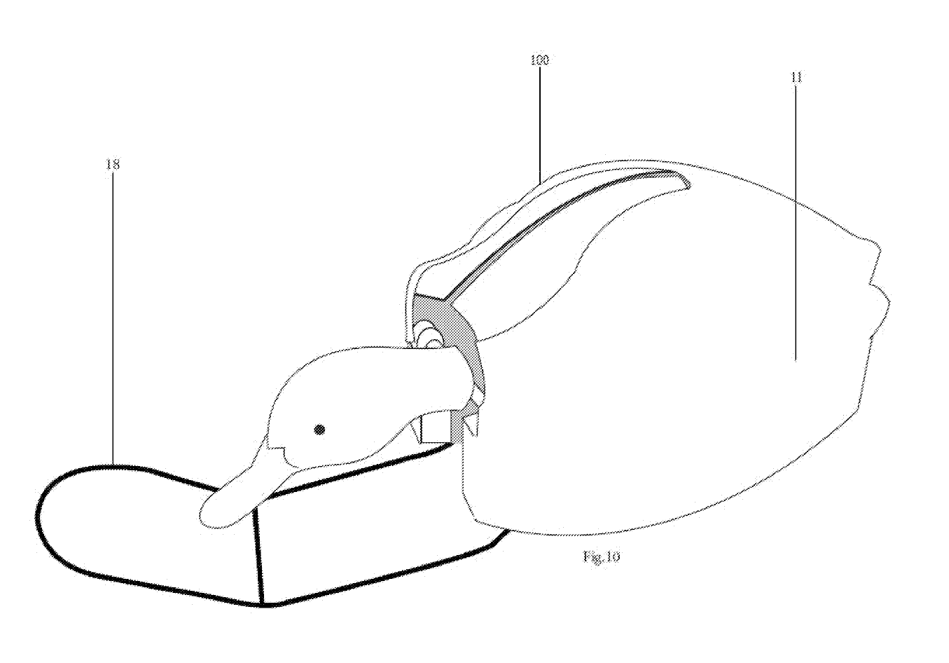

Referring to the drawings, FIG. 9 depicts a configuration of the waterfowl decoy 100 wherein the shaft 11 is connected to the motor 12 via a belt 16. The belt 16 shall be made of rubber, silicone, plastic or other flexible material. In this configuration, the operation of the motor 12 causes the belt 16 to rotate, which, then causes the shaft 11 to rotate, which rotates the decoy head in a circular motion.

Referring to the drawings, FIG. 9 further depicts a paddle wheel 17 attached to the shaft 11 in place of the decoy head 13. The paddle wheel is sized such that the length of each extension of the paddle wheel is the same length as the decoy head 13. The paddle wheel 13 functions the same as the decoy head 13 with respect to providing disturbance to the liquid surface and propelling the decoy 100.

Referring to the drawings, FIG. 10 depicts the mechanical waterfowl decoy 100 with a rigid guard 18 affixed to the underside of the buoyant body 14 which extends forward along the longitudinal axis of the mechanical waterfowl decoy 100 beyond the forward most position of the decoy head 13 or the paddle wheel 17. The rigid guard 18 shall be constructed of plastic, metal or other rigid material. The rigid guard 18 shall be shaped with a void space sufficient to permit clearance of the decoy head 13 or paddle wheel 17 during operation of the decoy. The rigid guard acts to prevent obstructions and debris from obstructing the rotation of the decoy head 13 or paddle wheel 17.

While this invention has been described with the specific embodiments outlines above, the preferred embodiments set forth are intended to be illustrative, not limiting. Various changes may be made without departing from the scope of the invention as defined in the following claims. The claims provide the scope of coverage of this invention and should not be limited to the specific examples cited above.

What is claimed is:

1. A mechanical waterfowl decoy for placing on the surface of a liquid comprising:
a buoyant decoy body having an access panel which opens to allow access to the interior of the decoy body;
a decoy head which is attached to a shaft and configured to rotate in a circular manner around the shaft so as to disturb the surface of the liquid on which the waterfowl decoy is place and to provide propulsion to the decoy;
a motor which is connected to said shaft and is configured to rotate the shaft; and
a power source configured to supply power to the motor

2. The mechanical waterfowl decoy of claim 1 further comprising a rigid guard.

3. The mechanical waterfowl decoy of claim 1, wherein the shaft is connected directly to the output of the motor.

4. The mechanical waterfowl decoy of claim 1, wherein the shaft is connected to the motor via a belt.

5. The mechanical waterfowl decoy of claim 2, wherein the shaft is connected directly to the output of the motor.

6. The mechanical waterfowl decoy of claim 2, wherein the shaft is connected to the motor via a belt.

7. A mechanical waterfowl decoy for placing on the surface of a liquid comprising:
a buoyant decoy body having an access panel which opens to allow access to the interior of the decoy body;
a paddle wheel which is attached to a shaft and configured to rotate in a circular manner around the shaft so as to disturb the surface of the liquid on which the waterfowl decoy is place and to provide propulsion to the decoy;
a motor which is connected to said shaft and is configured to rotate the shaft; and
a power source configured to supply power to the motor.

8. The mechanical waterfowl decoy of claim 7 further comprising a rigid guard.

9. The mechanical waterfowl decoy of claim 7, wherein the shaft is connected directly to the output of the motor.

10. The mechanical waterfowl decoy of claim 7, wherein the shaft is connected to the motor via a belt.

11. The mechanical waterfowl decoy of claim 8, wherein the shaft is connected directly to the output of the motor.

12. The mechanical waterfowl decoy of claim 8, wherein the shaft is connected to the motor via a belt.
